(19) United States
(12) Patent Application Publication
(10) Pub. No.: US 2025/0250849 A1
(43) Pub. Date: Aug. 7, 2025

(54) SECURITY FRAME CORNER CONNECTOR

(71) Applicant: Riot Glass, LLC, Huntington Beach, CA (US)

(72) Inventor: Terry Green, Anaheim, CA (US)

(21) Appl. No.: 19/041,938

(22) Filed: Jan. 30, 2025

Related U.S. Application Data
(60) Provisional application No. 63/550,386, filed on Feb. 6, 2024.

(51) Int. Cl. E06B 3/964; E06B 3/96; E06B 3/968

(52) U.S. Cl. CPC E06B 3/9644; E06B 3/968; E06B 3/9616

(57) ABSTRACT

A corner connector having a first connector leg; and a second connector leg associated with the first connector leg, such that a connector angle is formed between the first connector leg and the second connector leg, each connector leg having: a leg body; at least one engagement port nested within the leg body; at least one set screw configured to be nested within the at least one engagement port of the corresponding connector leg; and a pair of connector grooves nested within the leg body of the corresponding connector leg, wherein each connector groove of the pair of connector grooves is configured to engage with a corresponding complementary structure of a corresponding member of a security frame. The corner connector is configured to facilitate a secure, waterproof seal between security frame members that form mitered corners, such that fluid does not infiltrate into the corresponding security frame after installation.

### CROSS-REFERENCE TO RELATED APPLICATIONS

This application claims the benefit of U.S. Provisional Application No. 63/550,386, filed Feb. 6, 2024, which is hereby incorporated by reference, to the extent that it is not conflicting with the present application.

### BACKGROUND OF INVENTION

### 1. Field of the Invention

The invention relates generally to connectors and specifically to corner connectors for security frames.

### 2. Description of the Related Art

While many buildings are built with a particular level of security in mind, certain buildings may require additional security measures to be installed after their initial construction. Security frames are often utilized within the windows of buildings or other structures to provide a suitable mounting surface for the attachment of a security window/security panel over an existing window, to ensure that unauthorized access to the building through its windows is prevented. While security frames may provide a suitable mounting structure for the attachment of a security window or panel, certain limitations may exist that may negatively influence the function and longevity of the security frame.

One such limitation that exists is that due to the structure of a security frame, the shape of an engagement surface on a building, as well as several other factors, it may be difficult to ensure that that a waterproof seal is established in each corner of a security frame, which may be necessary to avoid having water enter the cavities within the security frame. Gaps formed between security frame elements during transportation or installation, such as gaps formed in mitered corners, may allow water to infiltrate into the security frame. In some applications, corners of the security frames may be pre-sealed within the factory during fabrication. If the corners are not securely connected together during fabrication, transportation damage may break the factory seals, thus allowing water to enter the security frame. The infiltration of water into a security frame may be undesirable for a variety of reasons, including potentially damaging the security frame, security panel or the building itself, as well as negatively influencing the building's general aesthetics (e.g., water vapor trapped between a preexisting glazing and a security panel may result in fogging between the glazing and security panel). Currently known methods of installing a security frame, such as a Riot Glass Gen II AP Series framing system, involve measuring and custom cutting each storefront bay individually on site and attaching to the surrounding framework. Butt-joined corners, which are commonly formed in such installations, are difficult to seal properly, thus resulting in the unwanted infiltration of water into the security frame. Existing security frames also tend to open at their corners as their corresponding fasteners are tightened, thus requiring several trials to achieve closed corner connections.

Additionally, due to the care needed to properly arrange the corners of a security frame, a significant amount of time may be needed to install a security frame on a building using conventional field installation methods. As establishing the desired connection between each corner member of a security frame may need to be done with the utmost care to establish a tamper proof seal, this portion of the process may take some time, increasing the time, and thus overall labor cost of installing a security frame. These labor costs may become significant as an average security frame covering a conventional window may have at least four corners, each of which may require special care to install properly.

Therefore, there is a need to solve the problems described above by proving a device and method for forming waterproof engagements between the members of a security frame.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a corner connector is provided, the corner connector comprising: a first connector leg; and a second connector leg associated with the first connector leg, such that an about 90 degree connector angle is formed between the first connector leg and the second connector leg, each connector leg comprising: a leg body having a terminal end; at least one engagement port nested within the leg body; at least one set screw configured to be nested within the at least one engagement port; a pair of beveled protrusions associated with the leg body; and a pair of connector grooves, wherein each connector groove is nested within a corresponding beveled protrusion of the pair of beveled protrusions, wherein each connector groove of the pair of connector grooves is configured to engage with a corresponding complementary structure of a corresponding member of a security frame. Thus, an advantage is that security frames having the disclosed corner connectors may be assembled within a factory as prefabricated, free-standing window structures. This may allow the amount of time spent in the field to install the security frame to be reduced, as the security frames may be preassembled before even being sent to the work site. This may be beneficial as a result of labor performed in the field generally being more expensive than labor performed in the controlled environment of a factory/production plant. Furthermore, by preassembling the security frames off site, the amount of disruption experienced at the installation site, which may be a business or other public establishment, may be reduced. Another advantage is that the corner connector may be configured to ensure that square corners (e.g., right angles) are formed and maintained between corner members during transport and installation, thus maintaining a visually appealing and stable structure and easing the installation of security frames with mitered corners within standard rectangular or square storefronts. Another advantage is that the plurality of set screws engaged with each connector leg of the corner connector may be configured to help establish a secure engagement between the corner members of a security frame prior to installing the sealant. As such, the already tight, secure fit of the two corner members using the corner connector may be made waterproof using conventional sealing techniques without needing to make further mechanical adjustment to corner connector positioning. Another advantage is that the corner connector may be configured to facilitate the secure connection of floating mullion within a security frame, thus providing an alternative mullion configuration where necessary or desired. The presence of a corner connector within a security frame may also reinforce the corresponding corner, mullion or other structures engaged with the corner connector, thus further improving the resilience of the security frame to forced entry attempts. Another advantage is that the utilization of the beveled protrusions on each connector leg may make it easier to insert each connector leg into its corresponding member of the security frame, thus reducing assembly time and making installation easier.

In another aspect, a corner connector is provided, the corner connector comprising: a first connector leg; and a second connector leg associated with the first connector leg, such that a connector angle is formed between the first connector leg and the second connector leg, each connector leg comprising: a leg body; at least one engagement port nested within the leg body; at least one set screw configured to be nested within the at least one engagement port; and a pair of connector grooves nested within the leg body, wherein each connector groove of the pair of connector grooves is configured to engage with a corresponding complementary structure of a corresponding member of a security frame. Again, an advantage is that security frames having the disclosed corner connectors may be assembled within a factory as prefabricated, free-standing window structures. This may allow the amount of time spent in the field to install the security frame to be reduced, as the security frames may be preassembled before even being sent to the work site. This may be beneficial as a result of labor performed in the field generally being more expensive than labor performed in the controlled environment of a factory/production plant. Furthermore, by preassembling the security frames off site, the amount of disruption experienced at the installation site, which may be a business or other public establishment, may be reduced. Another advantage is that the corner connector may be configured to ensure that square corners (e.g., right angles) are formed and maintained between corner members during transport and installation, thus maintaining a visually appealing and stable structure and easing the installation of security frames with mitered corners within standard rectangular or square storefronts. Another advantage is that the plurality of set screws engaged with each connector leg of the corner connector may be configured to help establish a secure engagement between the corner members of a security frame prior to installing the sealant. As such, the already tight, secure fit of the two corner members using the corner connector may be made waterproof using conventional sealing techniques without needing to make further mechanical adjustment to corner connector positioning. Another advantage is that the corner connector may be configured to facilitate the secure connection of floating mullion within a security frame, thus providing an alternative mullion configuration where necessary or desired. The presence of a corner connector within a security frame may also reinforce the corresponding corner, mullion or other structures engaged with the corner connector, thus further improving the resilience of the security frame to forced entry attempts.

In another aspect, a method of connecting members of a security frame together with a corner connector is provided, the security frame having: at least two members comprising: a first member and a second member configured to be engaged with the first member by the corner connector, the corner connector comprising: a first connector leg; and a second connector leg associated with the first connector leg, such that the first connector leg and second connector leg form a right angle with each other, each connector leg comprising: a leg body having a terminal end; four engagement ports nested within the leg body; four set screws, wherein each set screw of each connector leg is configured to be nested within a corresponding engagement port of the four engagement ports of the corresponding connector leg; and a pair of connector grooves nested within the leg body, wherein each connector groove of the pair of connector grooves is configured to engage with a corresponding complementary structure of a corresponding member of the at least two members of the security frame, the method comprising the steps of: partially engaging the first connector leg with the first member; partially engaging the second connector leg with the second member to engage the first member with the second member and form the security frame; injecting sealant into the security frame to form a waterproof engagement between the first member and the second member; fully engaging the first connector leg with the first member; and fully engaging the second connector leg with the second member. Again, an advantage is that security frames having the disclosed corner connectors may be assembled within a factory as prefabricated, free-standing window structures. This may allow the amount of time spent in the field to install the security frame to be reduced, as the security frames may be preassembled before even being sent to the work site. This may be beneficial as a result of labor performed in the field generally being more expensive than labor performed in the controlled environment of a factory/production plant. Furthermore, by preassembling the security frames off site, the amount of disruption experienced at the installation site, which may be a business or other public establishment, may be reduced. Another advantage is that the corner connector may be configured to ensure that square corners (e.g., right angles) are formed and maintained between corner members during transport and installation, thus maintaining a visually appealing and stable structure and easing the installation of security frames with mitered corners within standard rectangular or square storefronts. Another advantage is that the plurality of set screws engaged with each connector leg of the corner connector may be configured to help establish a secure engagement between the corner members of a security frame prior to installing the sealant. As such, the already tight, secure fit of the two corner members using the corner connector may be made waterproof using conventional sealing techniques without needing to make further mechanical adjustment to corner connector positioning. Another advantage is that the corner connector may be configured to facilitate the secure connection of floating mullion within a security frame, thus providing an alternative mullion configuration where necessary or desired. The presence of a corner connector within a security frame may also reinforce the corresponding corner, mullion or other structures engaged with the corner connector, thus further improving the resilience of the security frame to forced entry attempts.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the front perspective view of a corner connector, according to an aspect.

FIG. 2 illustrates the top perspective view of a security frame having a corner connector, according to an aspect.

FIGS. 3A-3D illustrate the front elevation, top plan, top perspective and bottom perspective views, respectively, of a corner connector engaging with a first security frame corner member, according to an aspect.

FIGS. 4A-4C illustrate the side cross-sectional, side perspective and top perspective views, respectively, of a corner connector engaging with a first security frame corner member, according to an aspect.

FIG. 5 illustrates the front perspective view of a security frame having an intermediate mullion engaged with a pair of corner connectors, according to an aspect.

FIG. 6 illustrates the front partial sectional view of a security frame having an intermediate mullion engaged with a pair of corner connectors, according to an aspect.

FIGS. 7A-7B illustrate the front sectional view and side sectional view, respectively, of a security frame having an intermediate mullion engaged with a pair of corner connectors, according to an aspect.

FIGS. 8A-8C illustrate the perspective views of an alternative embodiment of the corner connector, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 101 and 201, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

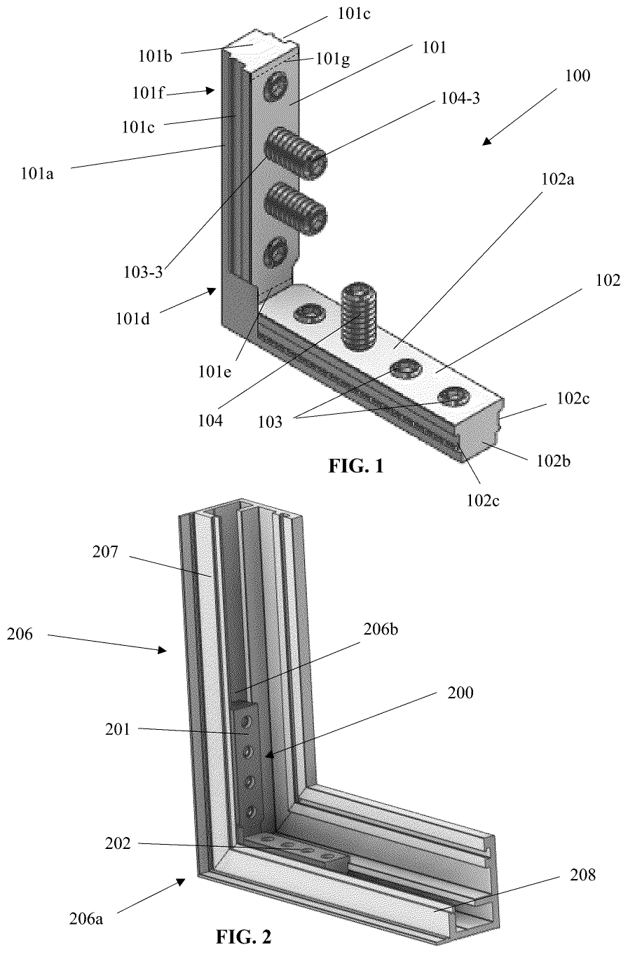

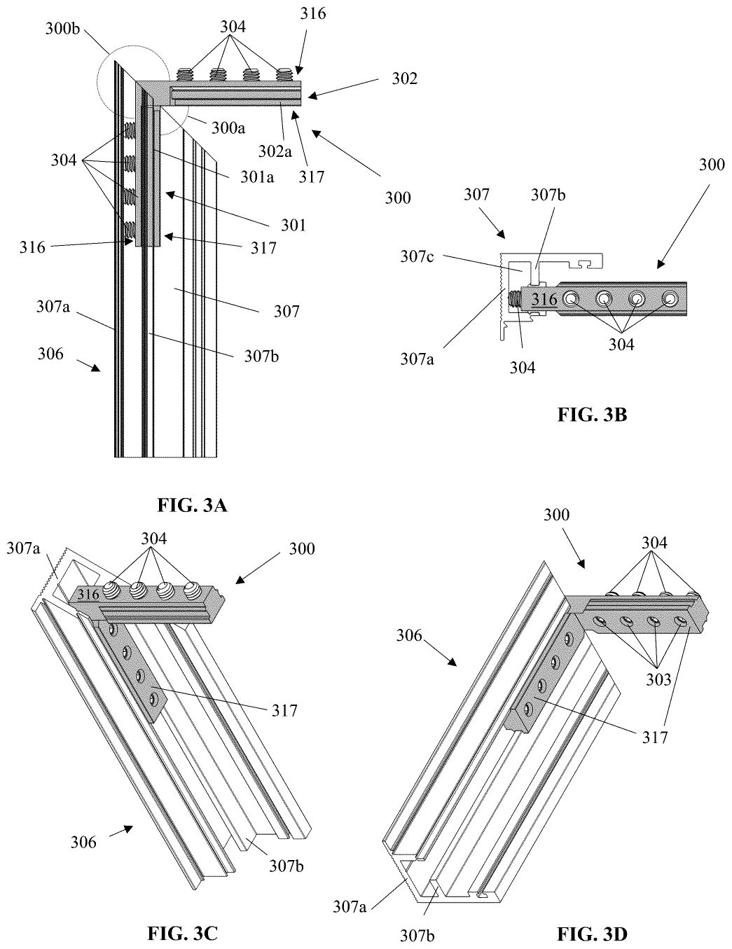

FIG. 1 illustrates the front perspective view of security frame corner connector 100, according to an aspect. A security frame corner connector (“corner connector”) 100 may be a fastening device configured to connect two members, such as corner members, of a security frame together. In an embodiment, the corner connector 100 may comprise a first connector leg 101 attached to or otherwise associated with a second connector leg 102 at a 90-degree angle, as shown in FIG. 1, such that the first connector leg 101 and second connector leg 102 are perpendicular to each other. The first connector leg 101 may have a first leg body 101a with a first terminal end 101b configured to be inserted within a corresponding first security frame corner member, such as first security frame corner member 207 of FIG. 2. Similarly, the second connector leg 102 may have a second leg body 102a with a second terminal end 102b configured to be inserted within a corresponding second security frame corner member, such as second security frame corner member 208 of FIG. 2. As will be described in greater detail hereinbelow, each connector leg 101, 102, may have a particular “keyed” shape configured to allow each connector leg 101, 102 to be securely engaged with a corresponding security frame member/profile, wherein the first connector leg 101 and second connector leg 102 may have the same shape.

In an embodiment, additional elements/structures may be nested within each connector leg 101, 102 in order to facilitate secure engagement of the corner connector 100 with the corresponding security frame members. In said embodiment, a plurality of engagement ports 103 may be nested within each connector leg 101, 102 of the corner connector 100. In an embodiment, the corner connector 100 may further comprise at least one set screw 104 nested within each connector leg 101, 102, wherein each set screw 104 is configured to be nested within a corresponding engagement port 103 nested within a corresponding connector leg 101, 102. For example, a third set screw 104-3 may be configured to be nested within a third engagement port 103-3, wherein said third engagement port 103-3 is nested within the first leg body 101a of the first connector leg 101. Each connector leg 101, 102 may have a plurality of engagement ports 103 nested within its corresponding leg body 101a, 102a. In an embodiment, at least one set screw 104 is configured to be engaged with each connector leg 101, 102, wherein each set screw 104 is configured to be nested within a corresponding engagement port 103 nested within the corresponding leg body 101a, 102a. Each set screw 104 may be manipulated to facilitate secure engagement between the corner connector 100 and the corresponding security frame members, as will be described in greater detail hereinbelow.

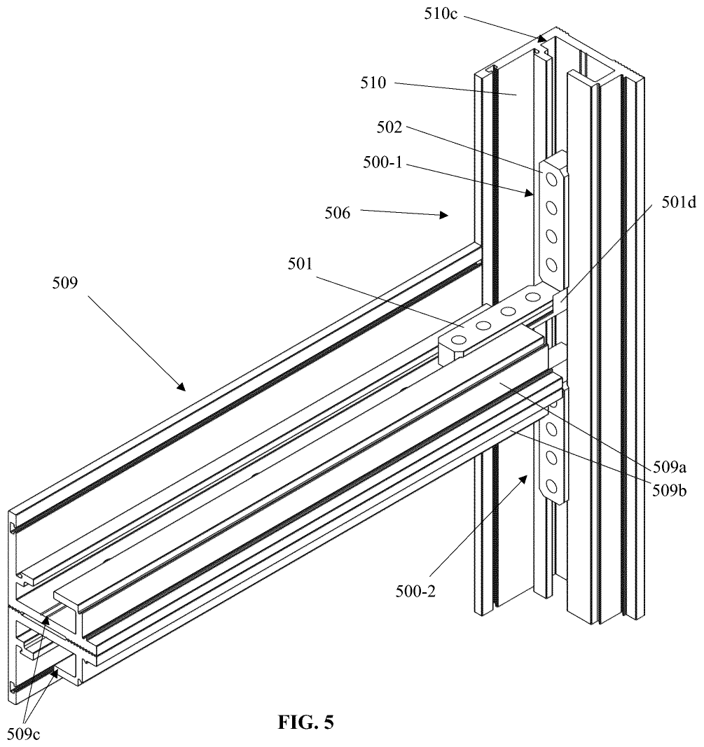

In an embodiment, each connector leg 101, 102 of the corner connector 100 may have a corresponding pair of connector grooves 101c, 102c nested within their corresponding leg body 101a, 102a. In said embodiment, a first pair of connector grooves 101c may be nested within the first leg body 101a and a second pair of connector groove 102c may nested within the second leg body 102a. As will be described in greater detail hereinbelow, these connector grooves 101c, 102c are configured to engage with a corresponding member/profile of a security frame. As can be seen in FIG. 1, the first leg body 101a may comprise an upper portion 101f having a pair of connector grooves 101c, and a lower portion 101d associated with the upper portion 101f. In an embodiment, the thickness 101e of the lower portion 101d may be less than the thickness 101g of the upper portion 101f, and the first pair of connector grooves 101c may not be present on the lower portion 101d of the first connector leg 101, as seen in FIG. 1. The lesser thickness 101e of the lower portion 101d of the first leg body 101a (when compared to the thickness 101g of the upper portion 101f) may provide sufficient clearance for the second leg 102 to run though a corresponding member/profile of the security frame for an intermediate mullion installation, as will be described in greater detail hereinbelow. As seen in FIG. 1, the second connector leg 102 may be directly attached with the lower portion 101d of the first connector leg 101 to enable the functionality relating to the second leg “running through” a corresponding member/profile of the security frame, as seen in FIG. 5.

FIG. 2 illustrates the top perspective view of a security frame 206 having a corner connector 200, according to an aspect. As disclosed hereinabove, the corner connector 200 may be configured to secure a first security frame corner member (“first corner member”, “first member”) 207 to a second security frame corner member (“second corner member”, “second member”) 208, to improve engagement and aid in establishing a waterproof seal between the two corner members 207, 208. In an embodiment, a standard square or rectangular security frame may have four corners 206a and thus may utilize four corner connectors 200 to help secure its corresponding corner members 207, 208 together. As seen in FIG. 2, the corner connector 200 may be configured to help secure the corner members 207, 208 together at a right angle, for compatibility within a standard window frame of a building. In an embodiment, the corner connector 200 having a pair of connector legs 201, 202 may be configured to allow for the rapid construction of prefabricated, complete security window units that are built to order, thus allowing the security frames to be fabricated quickly by the manufacturer off site. In said embodiment, the installer on site may only be required to seal the complete security window units to the perimeter of their corresponding window openings.

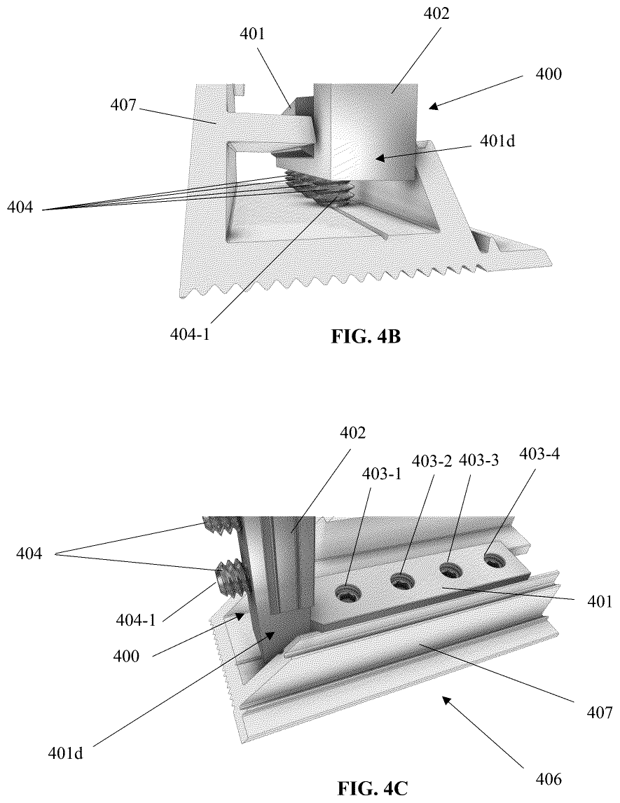

As can be seen in FIG. 2, when two corner members 207, 208 are attached to each other using a corner connector 200 to form a corner 206a, a security frame cavity 206b may also be formed within the security frame 206. This security frame cavity 206b may be formed by the now conjoined hollow portions (such as the hollow channels 407c of the corner member of FIG. 4A) of the corresponding security frame member 207, 208. As will be described hereinbelow, during construction of a security frame 206, a manufacturer may inject sealant into this security frame cavity 206b to ensure the formed corner 206a remains waterproof, to avoid infiltration of water into the security frame after installation on a structure. In an embodiment, the sealant may be introduced into the security frame cavity 206b through one of the engagement ports of one (or both) of the connector legs 201, 202, such as first engagement port 403-1 of FIG. 4C.

Through the utilization of disclosed corner connector 200, these security frames 206 may be assembled and evaluated within a controlled environment of a factory, thus simplifying installation and reducing overall labor costs. In an embodiment, security frame units are fabricated under controlled conditions with calibrated equipment and trained personnel in a factory. In said embodiment, corner leakage in between corner members 207, 208 can be controlled with mitered corners, critical sealing techniques and testing of the completed units prior to shipping. These factory-built security frames 206 will be more cost-effective to the customer, as a result of spending more time in shop fabrication and less time being installed at the installation site, thus significantly reducing overall cost. With shop time, on average, costing 30-40% less than the field labor rate, even though shop time may increase slightly, field time can be reduced by 50-75%. Faster installations facilitate an increase in margins and less inconvenience for the store owners.

The factory fabrication of pre-built, ready-to-install, security windows may open the market for these security frames to new customers that were ill suited for lengthier field installation processes. Stock and built-to-order sizes could be offered in home centers and building supply stores. Window showrooms may carry products with existing conventional window offerings. Other areas that may utilize security frames having the disclosed corner connectors might be transaction windows, hurricane retrofit windows, basement windows, and containment windows for institutional facilities.

In an embodiment, the corner connector 200 may be configured for use within Riot Glass Gen II AP Series framing systems. In said embodiment, the corner connector 200 may be suitably configured for utilization with all Gen II Riot Glass base fixtures, profiles and extrusions, such that the same corner connector 200 may be universally compatible within said configurations without the need for modifications. As is understood, the disclosed corner connector 200 may be utilized in Riot Glass Gen II AP Series framing systems in order to provide a solution to the time-consuming installation of Gen II systems when installed as a “stick-built unit” (piece-by-piece installation). The engagement of the corner members 207, 208 of a security frame 206 using the disclosed corner connector 200 will be described in greater detail hereinbelow.

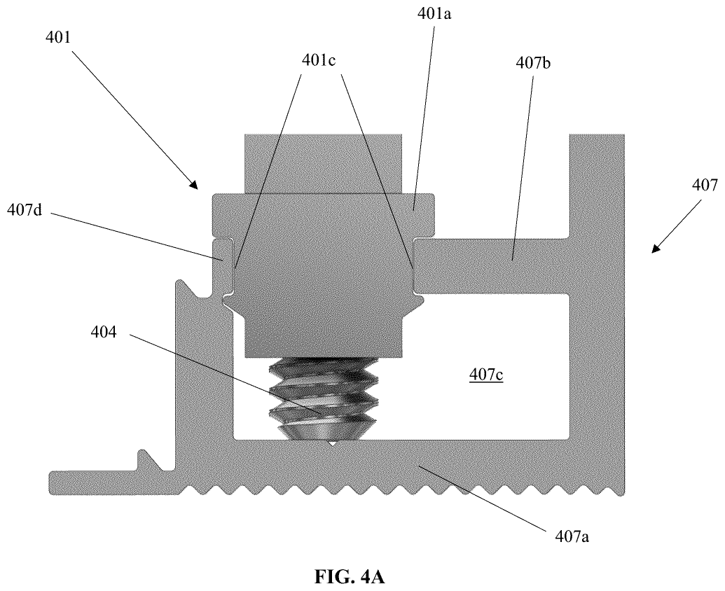

FIGS. 3A-3D illustrate the front elevation, top plan, top perspective and bottom perspective views, respectively, of a corner connector 300 engaging with a first security frame corner member 307, according to an aspect. As disclosed hereinabove, each corner connector 300 may be configured to engage with a first corner member 307 and a second corner member (such as second corner member 208 of FIG. 2), such that the corner members form a right angle with each other, as shown in FIG. 2. Each corner member 307 may have a suitably shaped hollow channel 307c within which the corresponding connector leg 301, 302 may be inserted, in order to engage the corner members 307 with each other. As such, the general shape of the first leg body 301a and the second leg body 302a may be adjusted in accordance with the corresponding channels, pockets or cavities present in the corner members 307 or those of any other members/profiles that are being engaged with each other.

As is understood from FIG. 3A-3C, each connector leg 301, 302 may have an interior surface 317 and an exterior surface 316 opposite the interior surface 317, such that the engagement ports 303 of a connector leg 301, 302 are disposed between the corresponding interior surface 317 and exterior surface 316 of the connector leg 301, 302. In an embodiment, as seen in FIG. 3A, the first leg connector leg 301 may be associated with the second connector leg 302 such that a corresponding connector angle 300a is formed between the interior surfaces 317 of the first and second connector legs 301, 302. In an embodiment, this connector angle 300a may be about 90 degrees. Similarly, an exterior connector angle 300b may be formed between the exterior surfaces 316 of each connector leg 301, 302, wherein the exterior connector angle 300b is about 270 degrees for the embodiment of FIG. 3A. Furthermore, as can also be seen in FIG. 2, security frame members 207, 208 having complementary structures for engagement with the connector legs may be engaged with the corner connector 200 to form the same connector angle, such as connector angle 300a of FIG. 3A, between the corresponding security frame members 207, 208. This may allow for the easy formation of right angles between members of a security frame without the utilization of any specialized angle measurement tools.

As described hereinabove, a plurality of set screws 304 may be nested within corresponding engagement ports 303 within each leg body 301a, 302a. Each set screw 304 may be adjusted via rotation (e.g., threading the set screw through the corresponding engagement port 303) in order to press securely against a corresponding base surface 307a of a corresponding corner member 307, such that each connector leg 301, 302 of a corner connector may be securely engaged with its corresponding corner member of the security frame. By having a plurality of set screws 304 engaged with each corner member 307 at several points along the corner members 307, it may be ensured that the first connector leg 301 remains parallel with the first corner member 307, as seen in FIG. 3A, and similarly, the second connector leg 302 remains parallel with the second corner member. Furthermore, the overall right angle shape of the corner connector 300 ensures that upon proper engagement of the first connector leg 301 with the first corner member 307 and the second connector leg 302 with the second corner member (such as second corner member 208 of FIG. 2), along with suitable adjustment of the set screws 304, the formed security frame may retain a right angle between the corresponding corner members, wherein the corner connector 300 does not slip out of either corner member.

In an embodiment, each corner member 307 of a security frame 306 may have a corresponding channel leg 307b, a corresponding base surface 307a, and a hollow channel 307c disposed between the channel leg 307b and the base surface 307a. In said embodiment, upon engagement of the corner connector 300 with the corresponding corner members, a portion of each connector leg 301, 302 may be configured to engage with a corresponding channel leg 307b, such that a part of each connector leg 301, 302 is nested within the hollow channel 307c of the corresponding corner member 307. For example, upon engagement of the first connector leg 301 with the channel leg 307b of the first corner member 307, the first connector leg 301 may be partially nested within the hollow channel 307c of the first corner member 307. Each corresponding set screw 304 on a connector leg 301 may also be seen extending into the corresponding hollow channel 307c to engage with the corresponding base surface, as described hereinabove. The particular structures of the corner connector 300 and the corner members 307 will be described in greater detail hereinbelow.

FIGS. 4A-4C illustrate the side cross-sectional, side perspective and top perspective views, accordingly, of a corner connector 400 engaging with a first security frame corner member 407, according to an aspect. In order to facilitate the engagement of corner members, such as corner members 207, 208 of FIG. 2, together as elements of a security frame, each connector leg 401, 402 of a corner connector 400 may be suitably shaped. In an embodiment, each corner member 407 may have a base surface 407a, a channel leg 407b associated with the base surface 407a, a hollow channel 407c disposed between the base surface 407a and the channel leg 407b, and a retaining leg 407d associated with the base surface 407a. In an embodiment, the corner connector 400 may be configured to engage with a corner member 407, such that the corresponding leg body 401a is disposed between the corresponding retaining leg 407d and the channel leg 407b of the corner member 407, as seen in FIG. 4A. In said embodiment, a pair of connector grooves 401c may be nested within each leg body 401a, such that the channel leg 407b is configured to be nested within one of the connector grooves 401c and the retaining leg 407d is configured to be nested within the other connector groove 401c upon engagement of the connector leg 401 with the corresponding corner member 407. As such, the retaining leg 407d and the channel leg 407b may be referred to as “complementary structures” disposed on a member/profile that are configured to engage with the connector grooves 401c of a corresponding connector leg 401. This in turn may help facilitate a secure engagement between each corner member 407 and the corner connector 400 that may resist deformations from impacts, wear-and-tear and other sources of damage, thus facilitating a robust security frame system.

As seen in FIG. 4A, a portion of each connector leg 401 may be nested within the hollow channel 407c of a corresponding corner member 407. The disclosed set screws 404 may be nested within the connector leg 401 and configured to engage with base surface 407a, thus further securing the connector leg 401 to its corresponding corner member 407. The set screws 404 may be configured to further prevent slippage between the connector legs, such as first connector leg 401, and their corresponding corner member, such as first corner member 407, while also helping to ensure a right angle is formed between the corner members engaged with the corresponding corner connector 400. These set screws 404 may be adjusted by suitable personnel (e.g., a factory worker/field installer) during fabrication and/or installation of the security frame 406, to ensure suitable engagement between the corner connector 400 and the corresponding corner members.

As described hereinabove, the disclosed corner connector 400 provides a connection vehicle for mitered corners on security frames, such as Riot Glass Gen II AP Series framing systems. The corner connectors 400 allow the security frames 406 to be built in a shop/factory as a free-standing window structure, unlike field-built units. This in turn saves time in the field and benefits from cheaper rates of labor present in shops, when compared to rates of labor common in the field. The corner connector 400 cradles the profiles of the corresponding corner members 407, thus forcing the formed security frame 406 to have square corners and tight joints prior to tightening the set screws 404. In an embodiment, each corner connector 400 may utilize eight set screws, as seen in FIG. 3A, thus facilitating this sealing feature while maintaining a strong, robust corner.

As is understood, security frames 406 assembled using the disclosed corner connectors 400 may also utilize a sealant in order to further seal their formed corners and prevent the infiltration of water into the security frame 406. In an embodiment, six of the eight set screws 404 engaged with the corner connector (e.g., three set screws on each connector leg 401) may be installed first though suitable rotation and subsequent engagement with the base surface 407a, such that each installed set screw 404 directly contacts (e.g., directly touches) the base surface 407a of the corresponding member 407, to secure the corner connector 400 to each corresponding corner member 407 (e.g., to prevent sliding of the corner connector 400 within the corresponding corner members 407, while leaving the innermost adjacent set screws 404-1 for each connector leg 401 (the set screws 404 that would be closest to the lower portion 401d of the first connector leg 401) loose/uninstalled. Next, a sealant may be injected into the now formed corner of the security frame 406, or more specifically, injected into the formed security frame cavity, such as security frame cavity 206b of FIG. 2, to further ensure water cannot enter the security frame 406 after installation. In an embodiment, first engagement ports 403-1 nested within the connector legs 401, 402 (e.g., the engagement ports on each connector leg that are to the lower portion 401d of the first connector leg 401) may be utilized as conduits for injecting sealant into the formed corner. Finally, the innermost adjacent set screws 404-1 on each connector leg 401, 402 are installed after injecting corner sealant into the formed corner, thus establishing a strong, waterproof seal for the formed corner.

In an embodiment, the three set screws 404 that are configured to be installed first during installation on each connector leg 401, 402, may be nested within the second, third and fourth engagement ports 403-2, 403-3, 403-4, of each connector leg 401, 402, and thus may be referred to as the second, third and fourth sets screws of the corresponding connector leg 401, 402, respectively. The installation of the second, third and fourth set screws within the second, third and fourth engagement ports 403-2, 403-3, 403-4 respectively, of a corresponding connector leg 401, 402, such that the second, third and fourth set screws engage directly with the corresponding member 407, may be described as “partially engaging” the corresponding connector leg 401, 402 with the corresponding member of the security frame. As is understood, the first engagement port 403-1 of each connector leg 401, 402 is configured to receive a corresponding innermost adjacent set screw 404-1 (which may also be referred to as the first set screw 404-1 for the connector leg) after the injection of the sealant into the newly formed corner/security frame cavity of the security frame. Through this mechanism, sealant may be injected through one (or both) of the first engagement port(s) 403-1 of the connector legs 401, 402, prior to the engagement of the corresponding first set screw 404-1 with its corresponding first engagement port 403-1.

The installation of the first set screws within the first engagement ports 403-1 of a corresponding connector leg 401, 402, such that the first set screws engage directly with the corresponding member 407, may be described as “fully engaging” the corresponding connector leg 401, 402 with the corresponding member 407 of the security frame 406. As such the process of installing a corner connector 400 within a security frame 406 may comprise the steps of: partially engaging the first connector leg 401 with the first member 407; partially engaging the second connector leg 402 with the second member (such as second member 208 of FIG. 2) to engage the first member with the second member and form the security frame 406; injecting sealant into the security frame 406 to form a waterproof engagement between the first member and the second member; fully engaging the first connector leg 401 with the first member 407; and fully engaging the second connector leg 402 with the second member.

In an embodiment, the shape of the corner connector 400 is structured specifically for compatibility with Riot Glass Gen II AP Series framing systems. The low tolerance transition or “keyed” fit between the corner connector 400 and the attached corner members 407 is configured to reduce frame twist during assembly. As is understood, this keyed fit may be seen in FIG. 4A, wherein the particular cross-sectional shape of each connector leg 401, 402 fits snuggly within corresponding hollow of the respective corner member 407 of a security frame, due in part to the particular size and shape of the connector grooves 401c on each connector leg 401, 402, and the engagement of the connector grooves with corresponding structures on the corresponding corner member 407. In said embodiment, the rotation of the set screws 404 for engagement with the base surface 407a does not change the mating alignment of the corners, but instead simply locks the corner member 407 and corner connector 400 into a fixed position. As is understood, that particular shape and structures of the disclosed corner connector 400 are configured to aid in rapid production of security frames having waterproof corners, thus providing customers with quick to install security solutions that water cannot enter.

FIG. 5 illustrates the front perspective view of a security frame 506 having an intermediate mullion 509 engaged with a pair of corner connectors 500-1, 500-2, according to an aspect. As can be seen in FIG. 5, the disclosed corner connectors 500-1, 500-2 may also be utilized at intermediate portions of a security frame (e.g., not just at an outer corner of the frame) in order to facilitate the installation of an intermediate mullion 509 within the security frame 506. In an embodiment, an intermediate mullion 509 comprising two intermediate mullion profiles (“mullion profile”, “intermediate mullion sections”) 509a, 509b may be secured to a perimeter member (“perimeter portion”, “perimeter profile”) 510 of a security frame 506 by two corner connectors 500-1, 500-2, with each corner connector 500-1, 500-2 being configured to engage a corresponding intermediate mullion profile 509a, 509b with the perimeter member 510, as shown in FIG. 5. It should be understood that a perimeter member 510 may refer to any part of a security frame that is at the outer perimeter of the security frame, which may include the corner members disclosed hereinabove. Furthermore, each corner connector 500-1, 500-2 may be secured to any member of a security frame (corner member, perimeter member, or any other member/profile of a security frame) depending on the desired configuration of the security frame.

As shown on the first corner connector 500-1, the first leg 501 of each corner connector 500-1, 500-2, may have a corresponding lower portion 501d, wherein the lower portion has a lesser thickness than the rest of the first leg 501. In an embodiment, this narrower, lower portion 501d on the first leg 501 of each corner connector 500-1, 500-2 may be configured to allow the second leg 501 of a corner connector 500-1, 500-2 to run through (and thus be partially nested within) the corresponding perimeter member 510 of a Riot Glass Gen II AP Series framing system, thereby increasing the functionality. In other words, the narrower, lower portion 501d of the first leg 501 may provide clearance between the second leg 502 and the remainder of the first leg 501, allowing the second leg 502 to slide though the hollow channel 510c of the perimeter member 510, without the first leg 501 colliding with the perimeter member 510. In this embodiment, the first leg 501 of each corner connector 500-1, 500-2 may be configured to be nested within the hollow channel 509c of a corresponding intermediate mullion profile 509a, 509b, as shown in FIG. 5.

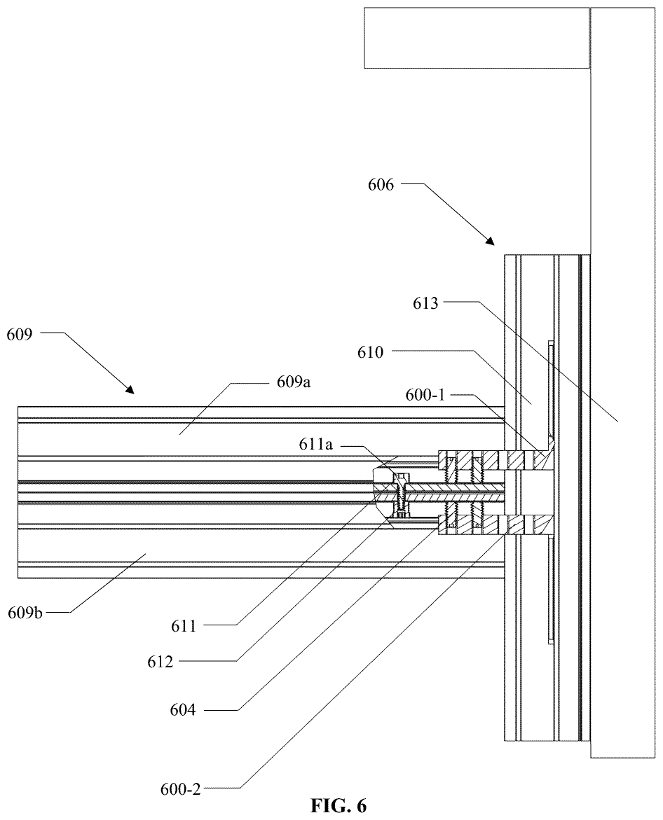

In an embodiment, the corner connectors 500 may be used as standard miter corner clip connector or, as seen in FIG. 5, may serve as an attachment device for two perpendicular Riot Glass Gen II AP Series framing system profiles, such as the described intermediate mullion profiles 509a, 509b of the intermediate mullion 509. As will be shown hereinbelow, these two back-to-back mullion profiles 509a, 509b may be attached together with thru-bolts, such as thru-bolt 611 of FIG. 6, to form the intermediate mullion 509. The utilization of an intermediate mullion 509 may allow for the covering of openings having sizes that exceed those of stock polycarbonate sheets by allowing two or more sheets or panels/sheets to be used to cover an opening. In other words, the utilization of an intermediate mullion may allow two or more sheets to be spliced together to form a single mulled security window.

FIG. 6 illustrates the front partial sectional view of a security frame 606 having an intermediate mullion 609 engaged with a pair of corner connectors 600, according to an aspect. As can be seen in FIG. 6, a security frame 606 may be secured to an original equipment manufacturer (OEM) storefront frame support structure 613 or perimeter window framing fixed to a building, to facilitate the covering of a window or other vulnerable portion of a building. For openings having a size that exceeds that of the available polycarbonate sheets or panels, an intermediate mullion 609 may be secured to a perimeter portion/perimeter member 610 of the security frame 606. As described hereinabove, the intermediate mullion 609 may comprise a first intermediate mullion profile 609a and a second intermediate mullion profile 609b. In an embodiment, the first intermediate mullion profile 609a may be secured to the second intermediate mullion profile 609b by a thru-bolt 611 configured be engaged with and driven through corresponding portions of the intermediate mullion profiles 609a, 609b. The thru-bolt 611 may be further engaged with a thru-bolt nut 612, such that the intermediate mullion profiles 609a, 609b are secured between a head 611a of the thru-bolt 611 and the thru-bolt nut 612.

As described hereinabove, the disclosed corner connectors 600-1, 600-2 may be configured to facilitate the installation of an intermediate mullion 609 within a security frame 606. As can be seen in FIG. 6, two back-to-back intermediate mullion profiles 609a, 609b may be thru-bolted together using the disclosed thru bolt 611 and thru-bolt nut 612, and attached to the perimeter portion 610 of the security frame 606 with the corner connectors 600-1, 600-2. These intermediate mullion profiles 609a, 609b are thus combined to become an intermediate horizontal or intermediate vertical mullion (depending on how the mullion profiles oriented) within the security frame 606. The intermediate mullion 609 may be attached at any point along the perimeter portion 610 of the security frame 606 depending on the desired security frame design, sizes of available security panels/polycarbonate sheets, etc. In an embodiment, the thru-bolt 611 may be a #10-24×1.0″ socket head cap screw, the thru-bolt nut 612 may be a #10-24 socket head cap nut and each utilized set screw 604 may be a #10-24 socket head set screw.

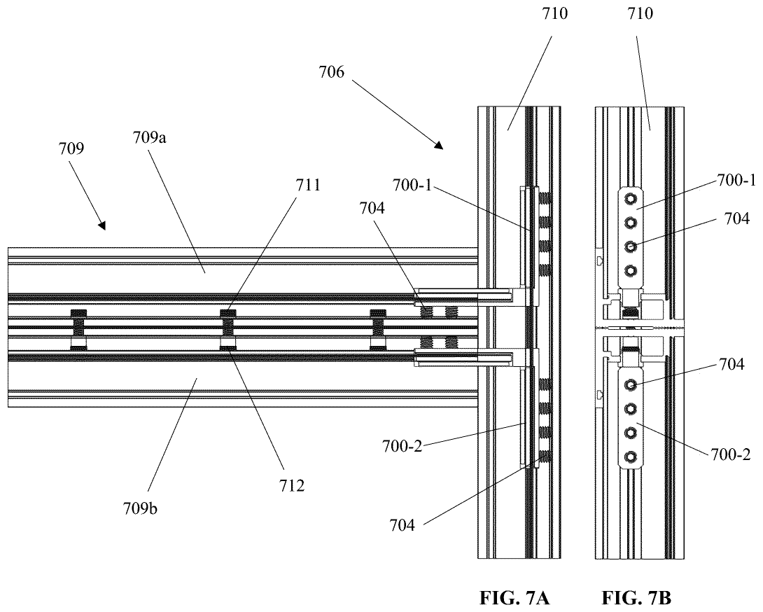

FIGS. 7A-7B illustrate the front sectional view and side sectional view, respectively, of a security frame 706 having an intermediate mullion 709 engaged with a pair of corner connectors 700, according to an aspect. As disclosed hereinabove, each corner connector 700-1, 700-2 may be configured to engage with a perimeter portion 710 of the security frame 706 and a corresponding intermediate mullion profile 709a, 709b of the intermediate mullion 709 through the utilization of the disclosed set screws 704. Furthermore, the intermediate mullion profiles 709a, 709b may be engaged with each other by one or more thru-bolts 711 and thru-bolt nuts 712, as described hereinabove. The specific quantity of thru-bolts 711, thru-bolt nuts 712 and set screws 704 utilized to facilitate engagement between their corresponding elements may be varied in accordance with the physical parameters of the security frame 706, the needs of the application, etc.

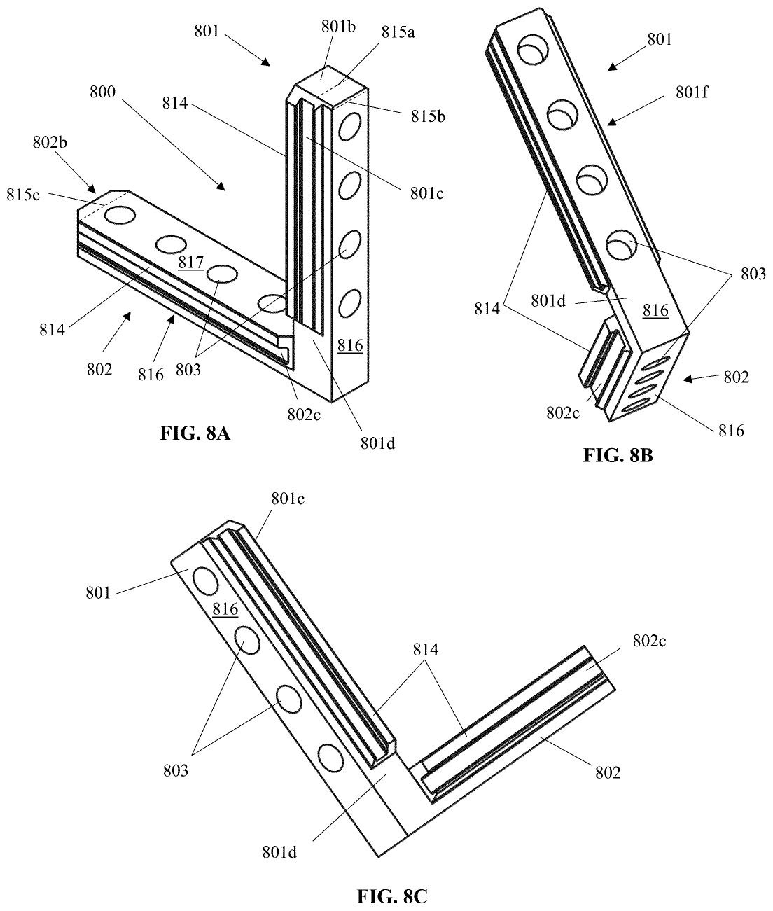

FIGS. 8A-8C illustrate the perspective views of an alternative embodiment of the corner connector 800, according to an aspect. Depending on the specific needs of a security framing system, the physical characteristics of a corresponding corner connector 800 may be suitably modified to provide proper engagement between security frame members/profiles. In an embodiment, each connector leg 801, 802 of a corner connector 800 may have a pair of beveled protrusions (“tapered protrusions”) 814, wherein a corresponding connector groove 801c, 802c is disposed on each beveled protrusion 814, as seen in FIG. 8A-8C. As seen in FIG. 8A, the particular shape of the beveled protrusions 814 may influence the shape of the terminal end of each connector leg 801, 802, such as the first terminal end 801b. As is understood, the engagement ports 803 of each connector leg 801, 802 may be disposed between the interior surface 817 and the exterior surface 816 of the corresponding connector leg 801, 802, as with the above-described embodiments.

As can be seen in FIG. 8A-8B, the beveled protrusions 814 influence the thickness of the corresponding connector legs 801, 802, due to the beveled protrusions 814 tapering to become thinner (and eventually stop) as they approach the corresponding terminal end 801b, 802b of the corresponding connector leg 801, 802. At a terminal end 801b, 802b of each connector leg 801, 802, the thickness of the connector leg may be lowest, as shown by the terminal end thickness line 815a. Due to the shape of the connector grooves 801c, 802c on each connector leg 801, 802 and the presence of the beveled protrusions 814, the thickness of the connector legs 801, 802 may be largest on the interior surface 817 of the corresponding connector leg 801, 802 at the location at which the beveled protrusion 814 become thickest, as shown by interior surface thickness line 815c.

Similarly, due the shape of the connector grooves 801c, 802c on each connector leg 801, 802 and the presence of the beveled protrusions 814, the thickness of the connector legs 801, 802 on the exterior surface 816 of the corresponding connector leg 801, 802 at the location at which the beveled protrusion 814 become thickest, as shown by exterior surface thickness line 815b, may be of an intermediate thickness. This intermediate thickness may be between the thicknesses of the terminal ends 801b, 802b (as expressed by thickness line 815a) and the thickness of the interior surface 817 where the beveled protrusions 814 are thickest, as expressed by thickness line 815c. As seen in FIG. 8B, each connector leg 801, 802 may comprise a leg body having an upper portion 801f attached to the beveled protrusions 814, and a lower portion 801d attached to the upper portion 801f. In an embodiment, the terminal end 801b, 802b of each connector leg 801, 802 may be disposed on the upper portion 801f of the leg body of the corresponding connector leg 801, 802, and that the beveled protrusions 814 of a connector leg may also disposed on the upper portion 801f of the leg body of the corresponding connector leg 801, 802.

The beveled protrusions 814 disposed on each leg connector 801, 802 may be configured to be at their thinnest at the terminal ends 101b, 102b of each connector leg 101, 102 to make it easier to nest each terminal end 801b in a corresponding hollow channel of a corresponding profile, such as hollow channel 407c of corner member 407 of FIG. 4A. The smaller size (e.g., lesser thickness) of the terminal ends 801b, 802b of FIG. 8A, when compared to terminal ends 101b, 102b of FIG. 1, may allow the terminal ends 801b, 802b of this alternative corner connector embodiment to be inserted more easily into the corresponding hollow channel of a profile, wherein the particular shape of the beveled protrusions 814 is configured to facilitate alignment of each connector leg 801, 802 with a corresponding member/profile of the security frame, as described hereinabove. In other words, each channel leg and retaining leg on a corresponding profile/member, such as channel leg 407b and retaining leg 407d of FIG. 4A, may be suitably nested within a corresponding connector groove 801c, 802c on the corresponding connector leg 801, 802. Thus, the resultant keyed fit between the connector legs 801, 802 of each corner connectors 800 and the corresponding profiles of the security frame may be established regardless of the corner connector embodiment 800 that is utilized.

In an embodiment, each corner connector 800 may be made of the same material as the profiles of the security framing system, such as aluminum, steel, or another suitably durable metal material. Similarly, each of the set screws, thru-bolts 811 and thru-bolt nuts 812 may also be made from suitably durable materials, such as aluminum, steel or another suitable metal. Additionally, it should be understood that the general dimensions, sizes, thickness, etc., of each element of a corner connector may be adjusted for compatibility with a corresponding structure of a security frame, or the specific requirements of a certain application as needed.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A corner connector comprising:
a first connector leg; and
a second connector leg associated with the first connector leg, such that an about 90 degree connector angle is formed between the first connector leg and the second connector leg, each connector leg comprising:
a leg body having a terminal end;
at least one engagement port nested within the leg body;
at least one set screw configured to be nested within the at least one engagement port;
a pair of beveled protrusions associated with the leg body; and
a pair of connector grooves, wherein each connector groove is nested within a corresponding beveled protrusion of the pair of beveled protrusions, wherein each connector groove of the pair of connector grooves is configured to engage with a corresponding complementary structure of a corresponding member of a security frame.

2. The corner connector of claim 1, wherein a thickness of each leg body is smallest at the terminal end of the corresponding leg body.

3. The corner connector of claim 1, wherein the leg body of the first connector leg further comprises an upper portion, wherein the beveled protrusions and terminal end are disposed on the upper portion, and a lower portion attached to the upper portion.

4. The corner connector of claim 3, wherein the second connector leg is attached to the lower portion of the leg body of the first connector leg.

5. The corner connector of claim 1, wherein the corner connector is made from aluminum.

6. The corner connector of claim 1, wherein the connector grooves of each connector leg are configured to engage with a channel leg and a retaining leg of the corresponding member of the security frame.

7. The corner connector of claim 1, wherein each connector leg comprises at least four engagement ports nested within the corresponding leg body and at least four set screws, wherein each set screw of the at least four set screws of each connector leg is configured to be nested within a corresponding engagement port of the at least four engagement ports of the corresponding connector leg.

8. A corner connector comprising:
a first connector leg; and
a second connector leg associated with the first connector leg, such that a connector angle is formed between the first connector leg and the second connector leg, each connector leg comprising:
a leg body;
at least one engagement port nested within the leg body;
at least one set screw configured to be nested within the at least one engagement port; and
a pair of connector grooves nested within the leg body, wherein each connector groove of the pair of connector grooves is configured to engage with a corresponding complementary structure of a corresponding member of a security frame.

9. The corner connector of claim 8, wherein the connector angle is about 90 degrees.

10. The corner connector of claim 8, wherein the leg body of the first connector leg further comprises an upper portion having the corresponding pair of connector grooves and a lower portion associated with the upper portion, wherein the second connector leg is directly attached to the lower portion of the leg body of the first connector leg.

11. The corner connector of claim 10, wherein a thickness of the lower portion of the first connector leg is less than a thickness of the upper portion of the first connector leg.

12. The corner connector of claim 8 wherein each connector leg comprises at least four engagement ports nested within the corresponding connector leg body and at least four set screws, wherein each set screw of the at least four set screw of each connector leg is configured to be nested within a corresponding engagement port of the at least four engagement ports of the corresponding connector leg.

13. The corner connector of claim 8, wherein the corner connector is made from aluminum.

14. The corner connector of claim 8, wherein the connector grooves of each connector leg are configured to engage with a channel leg and a retaining leg of the corresponding member of the security frame.

15. A method of connecting members of a security frame together with a corner connector, the security frame having: at least two members comprising: a first member and a second member configured to be engaged with the first member by the corner connector, the corner connector comprising: a first connector leg; and a second connector leg associated with the first connector leg, such that the first connector leg and second connector leg form a right angle with each other, each connector leg comprising: a leg body having a terminal end; four engagement ports nested within the leg body; four set screws, wherein each set screw of each connector leg is configured to be nested within a corresponding engagement port of the four engagement ports of the corresponding connector leg; and a pair of connector grooves nested within the leg body, wherein each connector groove of the pair of connector grooves is configured to engage with a corresponding complementary structure of a corresponding member of the at least two members of the security frame, the method comprising the steps of:
partially engaging the first connector leg with the first member;
partially engaging the second connector leg with the second member to engage the first member with the second member and form the security frame;
injecting sealant into the security frame to form a waterproof engagement between the first member and the second member;
fully engaging the first connector leg with the first member; and
fully engaging the second connector leg with the second member.

16. The method of claim 15, wherein partially engaging a first connector leg with the first member comprises nesting a second set screw, a third set screw and a fourth set screw of the four set screws of the first connector leg within their corresponding engagement ports, such that the second set screw, the third set screw and the fourth set screw of the first connector leg directly contact the first member.

17. The method of claim 15, wherein partially engaging a second connector leg with the second member comprises nesting a second set screw, a third set screw and a fourth set screw of the four set screws of the second connector leg within their corresponding engagement ports, such that the second set screw, the third set screw and the fourth set screw of the second connector leg directly contact the second member.

18. The method of claim 15, wherein injecting sealant into the security frame comprises injecting sealant through a corresponding first engagement port of the four engagement ports nested within each leg body.

19. The method of claim 16, wherein fully engaging the first connector leg with the first member comprises nesting a first set screw of the four set screws of the first connector leg within its corresponding engagement port of the four engagement ports of the first connector leg, such that the first set screw of the first connector leg directly contacts the first member.

20. The method of claim 17, wherein fully engaging the second connector leg with the second member comprises nesting a first set screw of the four set screws of the second connector leg within its corresponding engagement port of the four engagement ports of the second connector leg, such that the first set screw of the second connector leg directly contacts the second member.
